(19) United States
(12) Patent Application Publication
(10) Pub. No.: US 2024/0422025 A1
(43) Pub. Date: Dec. 19, 2024

(54) SYSTEM AND METHOD FOR AUTOMATICALLY ASSIGNING AN IDENTIFICATION NUMBER TO A PLURALITY OF NODE CONTROLLERS IN AN IRRIGATION SYSTEM

(71) Applicant: Lindsay Corporation, Omaha, NE (US)

(72) Inventors: Mark William Miller, Omaha, NE (US); Luke Joseph Barker, Omaha, NE (US); Steve J. Rubenthaler, Olathe, KS (US); Arnel Citurs, Omaha, NE (US)

(21) Appl. No.: 18/334,892

(22) Filed: Jun. 14, 2023

(51) Int. Cl. H04L 12/40

(52) U.S. Cl. CPC H04L 12/40078

(57) ABSTRACT

A control system for use with an irrigation system that includes a plurality of towers comprises a plurality of node controllers and a main controller. Each node controller is associated with a successive one of the towers and is configured to monitor operation of a plurality of components of the tower and to transmit data that includes a node identification number which corresponds to a positional number of the associated tower. The main controller is configured to receive the data. The control system executes a configuration process in which each node controller is assigned the node identification number in a sequence.

### FIELD OF THE INVENTION

Embodiments of the current invention relate to systems and methods for automatically assigning an identification number to node controllers that are part of an irrigation system.

### BACKGROUND

Agricultural irrigation systems include a plurality of towers that support a fluid-carrying conduit and a truss structure that retains a plurality of sprayers or nozzles which provide fluid to crops. Each tower includes propulsion components that move the system and a plurality of sensors and devices that monitor the system. Accordingly, each tower has a node controller that manages the operation of the components and monitors the data from the sensors. Each node controller transmits data to and receives instructions from a main controller that oversees operation of the irrigation system. Each node controller may be assigned a node identification number that corresponds to a positional number of the tower with which it is associated. The node identification number is typically included in data from each node controller in order to help a user, such as a system operator, identify and understand how the components of each tower are performing. The node identification numbers are usually assigned to each node controller manually, which requires a technician to interface with each node controller. The process can be time consuming and has to be performed when the system is installed, is reset, or when towers are replaced or added.

### SUMMARY OF THE INVENTION

Embodiments of the current invention address one or more of the above-mentioned problems and provide a distinct advance in the art of automatically setting up a plurality of node controllers in an irrigation system to include a node identification number with the data that they report to a main controller. Specifically, embodiments of the current invention provide control systems and methods for performing the setup which involves assigning the node identification number to each node controller according to a positional number of a tower associated with the node controller. The setup may be performed automatically anytime the controllers are powered on or when a node controller is replaced or added to the system. The setup may be performed onsite or remotely.

An embodiment of the control system broadly comprises the node controllers and the main controller. Each node controller is associated with a successive one of the towers and is configured to monitor operation of a plurality of components of the tower and to transmit data that includes the node identification number which corresponds to a positional number of the associated tower. The main controller is configured to receive the data. The control system executes a configuration process in which each node controller is assigned the node identification number in a sequence.

One embodiment of the method comprises disabling serial communication for each node controller; establishing communication between each node controller and the main controller for each node controller in order of a position of the associated tower; assigning a node identification number to each node controller when the node controller establishes communication with the main controller; and enabling serial communication for each node controller after its node identification number is assigned.

Another embodiment of the method comprises disabling serial communication for each node controller; establishing communication between each node controller and the main controller for each node controller in order of a position of the associated tower; establishing communication between each node controller and the other node controllers along a first direction of the towers; assigning a node identification number to each node controller after it establishes communication with the other node controllers along the first direction of the towers; and enabling serial communication for each node controller after its node identification number is assigned.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is an environmental view of a control system, constructed in accordance with various embodiments of the invention, for use with an irrigation system that includes a central pivot and a plurality of towers;

FIG. 2 is a schematic block diagram of the components of the control system including a main controller and a plurality of node controllers;

FIG. 3 is a schematic block diagram of the main controller including a processing element and a first port;

FIG. 4 is a schematic block diagram of one node controller including a first port, a second port, a processing port, and a processing element;

FIG. 5 is a listing of at least a portion of the steps of a first method for assigning a successive one of a plurality of node identification (ID) numbers to each of a plurality of node controllers; and

FIG. 6 is a listing of at least a portion of the steps of a second method for assigning a successive one of a plurality of node ID numbers to each of a plurality of node controllers.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

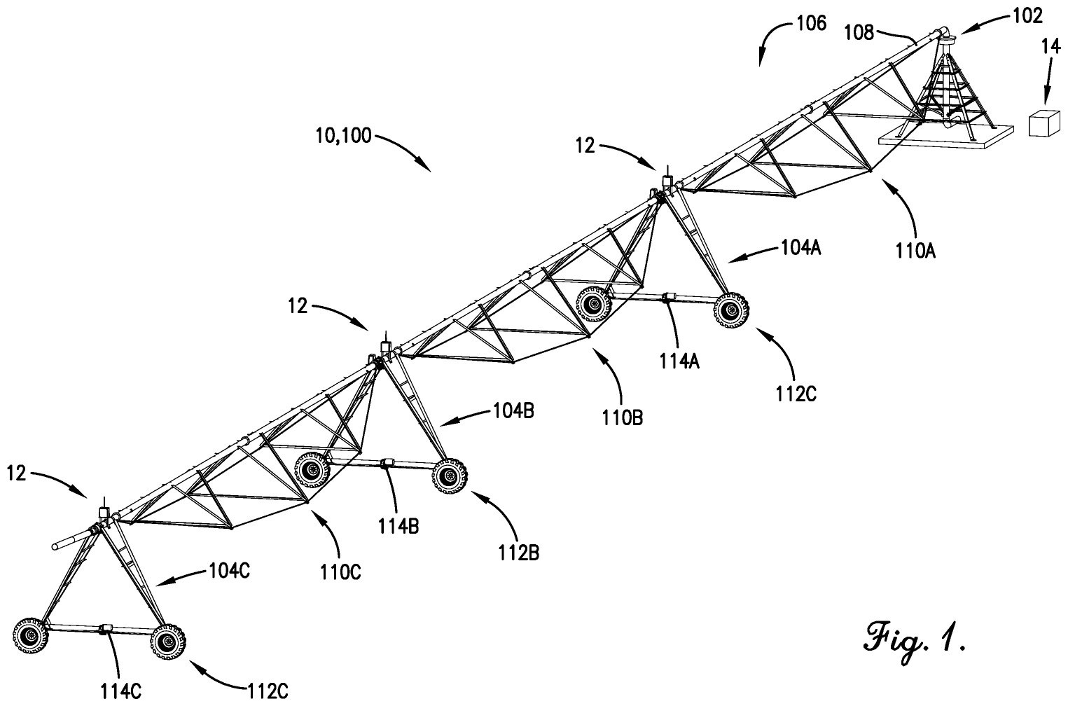

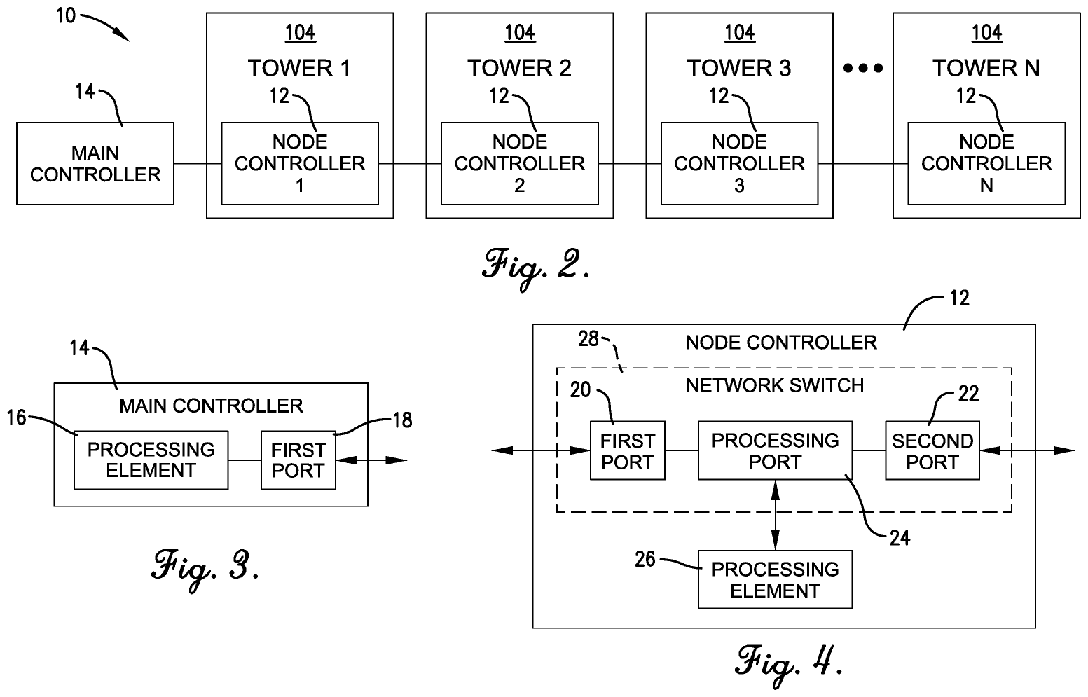

A control system 10, constructed in accordance with various embodiments of the current invention, for dynamically assigning a successive identification number to each of a plurality of node controllers 12 in an agricultural irrigation system 100 is shown in FIGS. 1 and 2. An exemplary irrigation system 100 includes, among other components, a central pivot 102 and a plurality of mobile towers 104 which support fluid delivery components and system drive components. Typically, a successive one of the node controllers 12 is retained by, associated with, and/or integrated with, each mobile tower 104. The control system 10 assigns an identification number to each node controller 12 that corresponds to a position number of the associated mobile tower 104, wherein lower numbers are closer to the central pivot 102 and higher numbers are farther from the central pivot 102. In addition, the terms “inbound” and “inboard” refer to a direction toward the central pivot 102, and the terms “outbound” and “outboard” refer to a direction away from the central pivot 102.

An exemplary embodiment of the irrigation system 100, shown in FIG. 1, is a central pivot irrigation system and broadly comprises the central pivot 102 and a main section 106 pivotally connected to the central pivot. The irrigation system 100 may also comprise an extension arm (also commonly referred to as a “swing arm” or “corner arm”) pivotally connected to the free end of the main section 106. The irrigation system 100 may also be embodied by a lateral, or linear, move apparatus which irrigates while moving in a linear, or near-linear, direction without departing from the scope of the current invention.

The central pivot 102 may be a fixed tower or any other support structure about which the main section 106 pivots. The central pivot 102 has access to a well, water tank, or other source of water and may also be coupled with a tank or other source of agricultural products to inject fertilizers, pesticides and/or other chemicals into the water for application during irrigation. The central pivot 102 supplies water to a conduit 108 or pipe which carries the water along the length of the main section 106.

The main section 106 may comprise any number of mobile towers 104A-C, the outermost mobile tower 104C of which is referred to herein as an end tower. The mobile towers 104A-C are connected to the fixed central pivot 102 and to one another by truss sections 110A-C or other supports to form a number of interconnected spans.

The mobile towers 104A-C have wheels 112A-C, at least one of which is driven by suitable drive motors 114A-C. Each motor 114A-C turns at least one of its wheels 112A-C through a drive shaft to propel its mobile tower 104 and thus the main section 106 in a circle about the central pivot 102 to irrigate a field. The motors 114 may also have several speeds or be equipped with variable speed drives. The operation of the motors 114A-C, such as whether they are on or off, the speed of travel, and the direction of travel, may be controlled with one or more electronic signals and/or digital data.

Each of the truss sections 110A-C carries or otherwise supports the conduit 108 and other fluid distribution mechanisms that are connected in fluid communication to the conduit 108. Fluid distribution mechanisms may include sprayers or diffusers, each optionally attached to a drop hose, or the like. In addition, the conduit 108 may include one or more valves which control the flow of water through the conduit 108. The opening and closing of the valves may be automatically controlled with an analog electronic signal and/or digital data.

The irrigation system 100 may also include wired or wireless communication electronic components that communicate with a communication network and allow the valves and the motors 114 to receive the electronic signals and/or digital data which control the operation of the valves and the motors 114.

The irrigation system 100 may also include an optional extension arm (not shown) pivotally connected to the end tower 104C and may be supported by a swing tower with steerable wheels driven by a motor. The extension arm may be joined to the end tower 104C by an articulating pivot joint. The extension arm is folded in relative to the end tower 104C when it is not irrigating a corner of a field and may be pivoted outwardly away from the end tower 104C while irrigating the corners of a field.

The irrigation system 100 illustrated in FIG. 1 has three mobile towers 104A-C; however, it may comprise any number of mobile support towers, truss sections, wheels, and drive motors without departing from the scope of the current invention.

The control system 10 broadly comprises a main controller 14 and the node controllers 12, as shown in FIG. 2. The main controller 14 may monitor and/or manage the operation of the irrigation system 100 in general or the node controllers 12 in particular. The main controller 14 may transmit and receive data to and from the node controllers 12. The main controller 14 includes a processing element 16 and a first port 18, as shown in FIG. 3. The main controller 14 may be housed in a housing, such as a computer tower housing or similar, that is positioned on site with the irrigation system 100, such as near the central pivot 102. Or, the main controller 14 may be located off site from the irrigation system 100 and may communicate with the other components through a wireless communication network.

The processing element 16 may comprise one or more processors. The processing element 16 may include electronic hardware components such as microprocessors (single-core or multi-core), microcontrollers, digital signal processors (DSPs), field-programmable gate arrays (FPGAs), analog and/or digital application-specific integrated circuits (ASICs), intelligence circuitry, or the like, or combinations thereof. The processing element 16 may generally execute, process, or run instructions, code, code segments, code statements, software, firmware, programs, applications, apps, processes, services, daemons, or the like. The processing element 16 may also include hardware components such as registers, finite-state machines, sequential and combinational logic, configurable logic blocks, and other electronic circuits that can perform the functions necessary for the operation of the current invention. In certain embodiments, the processing element 16 may include multiple computational components and functional blocks that are packaged separately but function as a single unit. In some embodiments, the processing element 16 may further include multiprocessor architectures, parallel processor architectures, processor clusters, and the like, which provide high performance computing. The processing element 16 may be in electronic communication with the other electronic components of the main controller 14 through serial or parallel links that include universal busses, address busses, data busses, control lines, and the like. In addition, the processing element 16 may include ADCs to convert analog electronic signals to (streams of) digital data values and/or digital to analog converters (DACs) to convert (streams of) digital data values to analog electronic signals. Furthermore, the processing element 16 may be in electronic communication with a data storage memory element. The processing element 16 may be operable, configured, and/or programmed to perform the functions, processes, methods, or algorithms of the main controller 14 by utilizing hardware, software, firmware, or combinations thereof.

The first port 18 generally provides communication with the node controllers 12. The first port 18 includes electronic circuitry, such as filters, amplifiers, light-emitting diodes, lasers, optical sensors, photo receivers, and the like, configured to transmit and receive an electronic signal or an optical signal that includes data generated by the processing element 16 or one of the node controllers 12. The first port 18 may further include connectors or couplers to connect to an electrically conductive metal or metal alloy cable or to an optical fiber cable.

Each node controller 12 may monitor and/or manage the operation of the components of the mobile tower 104 with which the node controller 12 is associated. Each node controller 12 may transmit and receive data to and from the main controller 14 and other node controllers 12. Each node controller 12 includes a first port 20, a second port 22, a processing port 24, and a processing element 26, as shown in FIG. 4. The first port 20, the second port 22, and the processing port 24 may form or may embody a network switch 28 which has a network address, such as an internet protocol (IP) address or a media access control (MAC) address. The network switch 28 is configured to handle (i.e., transmit and receive) packet-based data, such as ethernet network data.

The first port 20 and the second port 22 each may have a component structure that is substantially similar to, or the same as, the structure of the first port 18 of the main controller 14 and may connect to an electrically conductive metal or metal alloy cable or to an optical fiber cable.

The processing port 24 generally receives and transmits data to and from the first port 20 and the second port 22 and provides communication with the processing element 26. Any data that is addressed to the current node controller 12 is received from the first port 20 or the second port 22, is communicated to the processing port 24, and is forwarded to the processing element 26. Any data intended for the main controller 14 is communicated from the processing element 26 to the processing port 24, transferred to the first port 20, and transmitted to the inbound node controller 12 or to the main controller 14. The processing port 24 includes electronic circuitry, such as filters, amplifiers, and the like, configured to transmit and receive an electronic signal that includes data. The processing port 24 may communicate through electrically conductive components, such as electrically conductive traces on a printed circuit board.

The processing element 26 may have a structure that is substantially similar to, or the same as, the structure of the processing element 16. The processing element 26 may be operable, configured, and/or programmed to perform the functions, processes, methods, or algorithms of the node controller 12, such as monitor and/or manage the operation of the components of the mobile tower 104 with which the node controller 12 is associated, by utilizing hardware, software, firmware, or combinations thereof.

The second port 22, and optionally the first port 20 and the processing port 24, are capable of selectively being enabled or disabled through software settings. For example, the second port 22 may be disabled so that it does not transmit or receive any signals or may be enabled so that it does transmit and receive signals. When all the ports 20, 22 are enabled, the network switch 28 performs a switching function. That is, data, or packets, are received on the first port 20 and the second port 22. Those packets that are intended for the associated node controller 12 are transferred to the processing port 24 to be communicated to the processing element 26. Those packets that are intended for other node controllers 12 or the main controller 14 are transferred from the first port 20 to the second port 22 or from the second port 22 to the first port 20, depending on the direction of data flow.

Referring to FIGS. 2-4, the control system 10 may have a structure as follows. The first port 18 of the main controller 14 is connected, though electrically conductive cable or optical fiber, to the first port 20 of the first node controller 12, which is collocated and associated with the first mobile tower 104. The second port 22 of the first node controller 12 is connected, though electrically conductive cable or optical fiber, to the first port 20 of the second node controller 12. The remaining node controllers 12, each of which is collocated and associated with a successive one of the mobile towers 104, are connected in the same fashion, with the second port 22 of a lower numbered node controller 12 connected to the first port 20 of a higher numbered node controller 12—except for the last node controller 12, whose second port 22 is not connected to any other component. In other words, the first port 20 of each node controller 12 (except the first node controller 12) is connected to an inbound node controller 12 and the second port 22 of each node controller 12 (except the last node controller 12) is connected to an outbound node controller 12. The connection of the main controller 14 and the node controllers 12 forms a serial communication network in which data flows through one or more node controllers 12 to be received by the main controller 14 or other node controllers 12.

In other embodiments, the components of the control system 10 may communicate with one another wirelessly. The main controller 14 and each node controller 12 may include a radio frequency wireless transmitter and a radio frequency wireless receiver that can be selectively enabled or disabled.

The control system 10 may operate as follows. (In the following description, the terms “processing element 16 of the main controller 14” and “main controller 14” may be used interchangeably given that the processing element 16 generally performs the functions of the main controller 14. And, the terms “processing element 26 of each/the node controller 12” and “node controller 12” may be used interchangeably given that the processing element 26 generally performs the functions of each/the node controller 12.) When the control system 10 is installed, the main controller 14 and each node controller 12 is placed in an auto configuration mode. The auto configuration mode may be entered by default when the controllers 12, 14 are powered on. In addition, at other times, such as when mobile towers 104 are removed, replaced, or added, the main controller 14 and each node controller 12 may be placed in the auto configuration mode. In certain situations, the processing element 16 of the main controller 14 may send data or instructions that is received by the processing element 26 of each node controller 12 which places the main controller 14 and each node controller 12 in the auto configuration mode.

In the auto configuration mode, the following operations or steps take place. The main controller 14 awaits communication from each node controller 12 and initializes a node identification (ID) counter with a value of 1. The main controller 14 may also start a timer for the auto configuration process. The processing element 26 of each node controller 12 disables its second port 22, or the second port 22 is disabled manually, such as during installation. Each node controller 12 (repeatedly) tries to contact, ping, or send an announcement message to, the main controller 14. Since the second port 22 of each node controller 12 is disabled, only the first node controller 12 can communicate with the main controller 14. The first node controller 12 transmits a message to the main controller 14. The main controller 14 recognizes that the message has come from a new network address and, in return, responds to the first node controller 12 with instructions for the first node controller 12 to assign itself with a node ID number of 1 based on the value of the node ID counter, and the main controller 14 may associate, such as in a lookup table, the network address of the first node controller 12 with the node ID number of 1. The main controller 14 also increments the value of the node ID counter. In addition, the main controller 14 responds to the first node controller 12 with instructions for the first node controller 12 to enable its second port 22.

The second node controller 12, now able to contact the main controller 14 through the first node controller 12, transmits a message to the main controller 14. The main controller 14 recognizes that the message has come from a new network address and, in return, responds to the second node controller 12 with instructions for the first node controller 12 to assign itself with a node ID of the current value (2) of the node ID counter, and the main controller 14 associates the network address of the second node controller 12 with the node ID of 2. The main controller 14 also increments the value of the node ID counter. In addition, the main controller 14 responds to the second node controller 12 with instructions for the second node controller 12 to enable its second port 22.

The remaining node controllers 12 contact the main controller 14 in the same fashion, in sequential order from lower-numbered node controllers 12 to higher-numbered node controllers 12. The main controller 14 instructs each node controller 12 to assign its node ID to the current value of the node ID counter and to enable its second port 22, wherein the main controller 14 increments the value of the node ID counter after being contacted by each node controller 12. The main controller 14 may also record the association between the node ID number and the network address of each node controller 12. The main controller 14 is not programmed or configured with the total number of node controllers 12 are connected in the control system 10 because the number is variable. Accordingly, the main controller 14 waits until the timer, started at the beginning of the auto configuration process, runs out before stopping the auto configuration process. Typically, the timer is set for a much longer time than it takes for the process to complete. Once the timer runs out, the main controller 14 transmits instructions to each node controller 12 to enter a normal operation mode. In the normal operation mode, each node controller 12 transmits data regarding its operation to the main controller 14. Each node controller 12 may also transmit its node ID number along with each piece of data. Additionally, or alternatively, the main controller 14 may check the node ID number associated with the network address of each piece of data it receives.

In other embodiments, the control system 10 may perform the auto configuration process as follows. Each node controller 12: has its second port 22 disabled, has its own node ID counter, and repeatedly tries to contact the main controller 14. The first node controller 12 sends a message to the main controller 14 and receives a reply. When it receives the reply from the main controller 14, the first node controller 12 sets its node ID counter value to 1. The first node controller 12 attempts to contact the node controller 12 with a node ID number that equals the current value of its node ID counter. In this case, the first node controller 12 attempts to contact node controller 12 #1, which is itself. It cannot contact itself, so the first node controller 12 sets its node ID number to the current value of its node ID counter, which is 1. The first node controller 12 also enables its second port 22. In addition, the first node controller 12 places itself in a normal operation mode, in which it transmits operational data to the main controller 14, wherein the data is accompanied by the node ID number.

With the second port 22 of the first node controller 12 enabled, the second node controller 12 contacts the main controller 14 and receives a reply. When it receives the reply from the main controller 14, the second node controller 12 sets the node ID counter value to 1. The second node controller 12 attempts to contact the node controller 12 with a node ID number that equals the current value of its node ID counter. In this case, the second node controller 12 attempts to contact node controller 12 #1. Since the second port 22 of the first node controller 12 is enabled, the second node controller 12 contacts the first node controller 12 and receives a reply. The second node controller 12 increments the value of its node ID counter (to 2). The second node controller 12 attempts to contact node controller 12 #2, which is itself. It cannot contact itself, so the second node controller 12 sets its node ID number to the current value of its node ID counter, which is 2. The second node controller 12 also enables its second port 22. In addition, the second node controller 12 places itself in a normal operation mode, in which it transmits operational data to the main controller 14, wherein the data is accompanied by the node ID number.

The remainder of the node controllers 12 establish their node ID number in the same fashion, in sequential order from lower-numbered node controllers 12 to higher-numbered node controllers 12. Each node controller 12 first contacts the main controller 14 and then contacts the other node controllers 12 in sequential, numerical order starting with the first node controller 12. Every time it contacts another node controller 12, each node controller 12 increments its node ID counter until it reaches its own node ID number and it tries to contact itself. Then, the node controller 12 sets its node ID number according to the node ID counter value, it enables its second port 22, and places itself in the normal operating mode.

If a node controller 12 is replaced, then the newly-added node controller 12 is placed in the auto configuration mode. Once it determines its node ID number, then the newly-added node controller 12 places itself in the normal operation mode. If a new node controller 12 is added to the control system 10, then the new node controller 12 and each of the higher-numbered node controllers 12 are placed in the auto configuration mode. Once each node controller 12 determines its node ID number, then it places itself in the normal operation mode.

The control system 10 may also be used with a lateral move irrigation system that has a two-sided right-hand (RH) flank and left-hand (LH) flank implementation. In some embodiments, the control system 10 may include a first main controller 14 and a second main controller 14. The first main controller 14 may communicate with the RH flank, and the second main controller 14 may communicate with the LH flank. The control system 10 may execute either of the auto configuration processes described above. In other embodiments, the main controller 14 may include the first port 18 and a second port, similar to the first port 18. The first port 18 may communicate with the RH flank, and the second port may communicate with the LH flank. The control system 10 may execute either of the auto configuration processes described above. In still other embodiments, the control system 10 may include the main controller 14 as described above. The LH flank may be disconnected from the main controller 14 while the auto configuration process is executed for the RH flank. And the RH flank may be disconnected from the main controller 14 while the auto configuration process is executed for the LH flank.

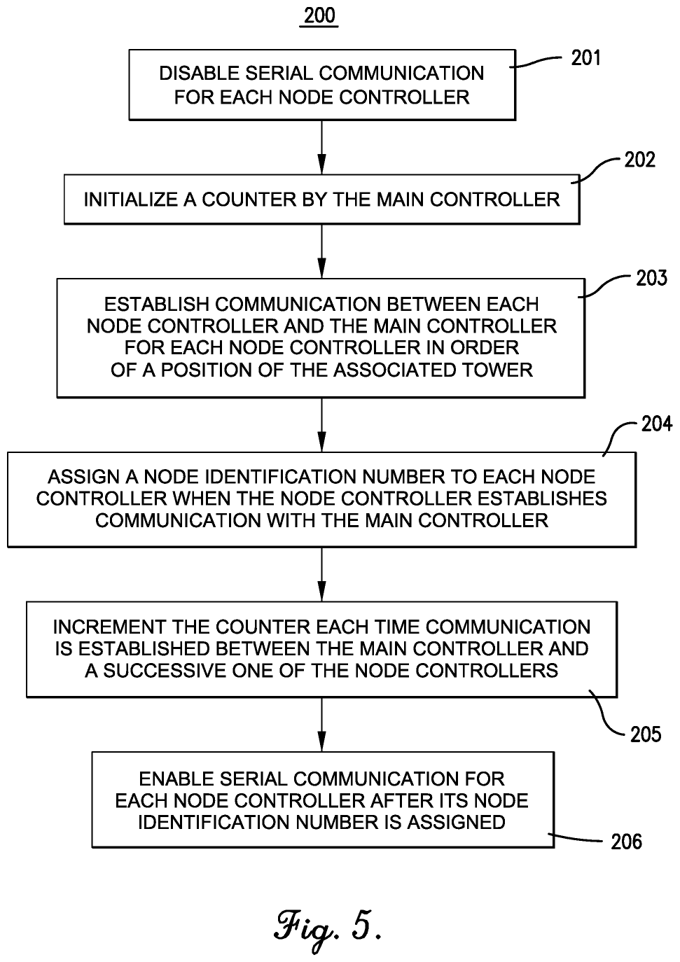

FIG. 5 depicts a listing of at least a portion of the steps of a first exemplary method 200 for assigning a successive one of a plurality of node identification (ID) numbers to each of a plurality of node controllers 12. The node controllers 12 are connected in series with one another and a main controller 14 to form a serial communication network. In addition, each node controller 12 is associated with a successive one of a plurality of mobile towers 104 of an irrigation system 100. The steps may be performed in the order shown in FIG. 5, or they may be performed in a different order. Furthermore, some steps may be performed concurrently as opposed to sequentially. In addition, some steps may be optional or may not be performed. The steps may be performed by the processing element 16 and/or one or more of the processing elements 26 via hardware, software, firmware, or combinations thereof. Furthermore, the steps may be implemented as instructions, code, code segments, code statements, a program, an application, an app, a process, a service, a daemon, or the like, and may be stored on a computer-readable storage medium, such as memory elements associated with the processing element 16 and/or the processing elements 26.

Referring to step 201, serial communication for each node controller 12 is disabled. Each node controller 12 may monitor and/or manage the operation of the components of the mobile tower 104 with which the node controller 12 is associated. Each node controller 12 may transmit and receive data to and from the main controller 14 and other node controllers 12. Each node controller 12 includes a first port 20, a second port 22, a processing port 24, and a processing element 26, as shown in FIG. 4. The first port 20, the second port 22, and the processing port 24 may form or may embody a network switch 28 which has a network address, such as an internet protocol (IP) address or a media access control (MAC) address. The network switch 28 is configured to handle (i.e., transmit and receive) packet-based data, such as ethernet network data.

The first port 20 and the second port 22 each may have a component structure that is substantially similar to, or the same as, the structure of the first port 18 of the main controller 14 and may connect to an electrically conductive metal or metal alloy cable or to an optical fiber cable.

The processing port 24 generally receives and transmits data to and from the first port 20 and the second port 22 and provides communication with the processing element 26. Any data that is addressed to the current node controller 12 is received from the first port 20 or the second port 22, is communicated to the processing port 24, and is forwarded to the processing element 26. Any data intended for the main controller 14 is communicated from the processing element 26 to the processing port 24, transferred to the first port 20, and transmitted to the inbound node controller 12 or to the main controller 14. The processing port 24 includes electronic circuitry, such as filters, amplifiers, and the like, configured to transmit and receive an electronic signal that includes data. The processing port 24 may communicate through electrically conductive components, such as electrically conductive traces on a printed circuit board.

The processing element 26 may have a structure that is substantially similar to, or the same as, the structure of the processing element 16. The processing element 26 may be operable, configured, and/or programmed to perform the functions, processes, methods, or algorithms of the node controller 12, such as monitor and/or manage the operation of the components of the mobile tower 104 with which the node controller 12 is associated, by utilizing hardware, software, firmware, or combinations thereof.

The second port 22, and optionally the first port 20 and the processing port 24, are capable of selectively being enabled or disabled through software settings. For example, the second port 22 may be disabled so that it does not transmit or receive any signals or may be enabled so that it does transmit and receive signals. When all the ports 20, 22 are enabled, the network switch 28 performs a switching function. That is, data, or packets, are received on the first port 20 and the second port 22. Those packets that are intended for the associated node controller 12 are transferred to the processing port 24 to be communicated to the processing element 26. Those packets that are intended for other node controllers 12 or the main controller 14 are transferred from the first port 20 to the second port 22 or from the second port 22 to the first port 20, depending on the direction of data flow.

Referring to step 202, a node ID counter is initialized with a value of 1 by the main controller 14.

Referring to step 203, communication between each node controller 12 and the main controller 14 is established for each node controller 12 in order of a position of the associated mobile tower 104. Each node controller 12 (repeatedly) tries to contact, ping, or send an announcement message to, the main controller 14. Since the second port 22 of each node controller 12 is disabled, only the first node controller 12 can communicate with the main controller 14. The first node controller 12 transmits a message to the main controller 14. The remaining node controllers 12 transmit a message to the main controller 14 as the steps listed below are performed repeatedly in sequence.

Referring to step 204, a node ID number is assigned to each node controller 12 when the node controller 12 establishes communication with the main controller 14. The node ID number is assigned according to a value of the node ID counter. In addition, the main controller 14 transmits instructions to each node controller 12 to assign itself with the node ID number based on the value of the node ID counter.

Referring to step 205, the counter is incremented each time communication is established between the main controller 14 and a successive one of the node controllers 12.

Referring to step 206, serial communication for each node controller 12 is enabled after its node identification number is assigned. Serial communication is enabled by the processing element 16 transmitting instructions to each node controller 12 to enable its second port 22, which allows node controllers 12 with higher node ID numbers to communicate through node controllers 12 with lower node ID numbers.

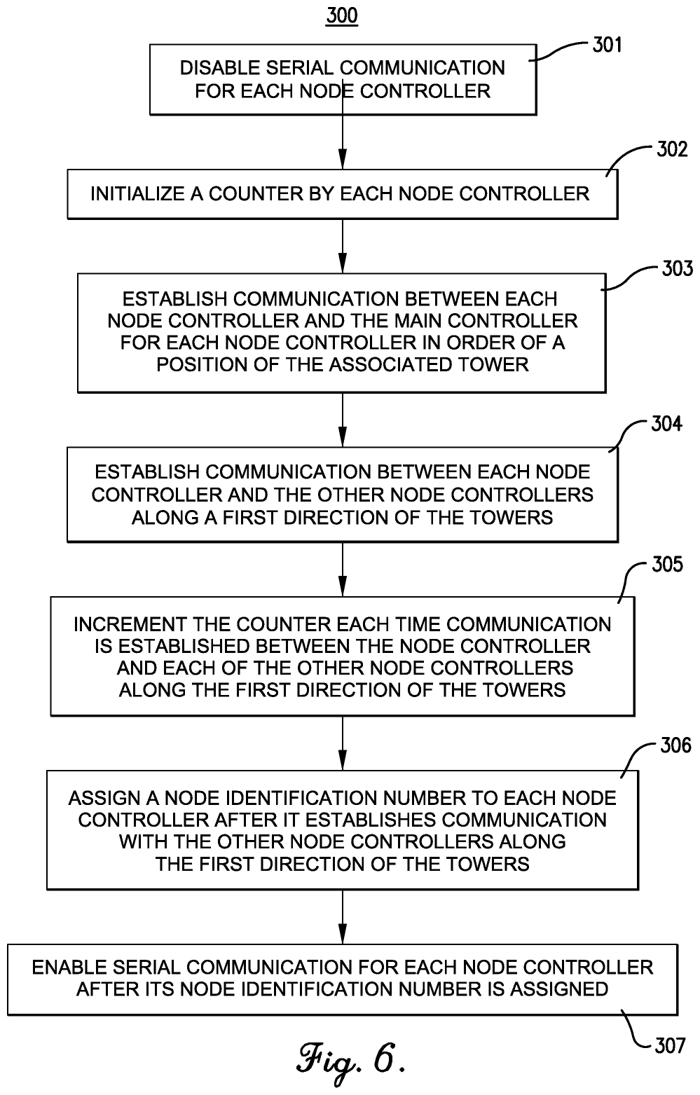

FIG. 6 depicts a listing of at least a portion of the steps of a second exemplary method 300 for assigning a successive one of a plurality of node identification (ID) numbers to each of a plurality of node controllers 12. The node controllers 12 are connected in series with one another and a main controller 14 to form a serial communication network. In addition, each node controller 12 is associated with a successive one of a plurality of mobile towers 104 of an irrigation system 100. The steps may be performed in the order shown in FIG. 6, or they may be performed in a different order. Furthermore, some steps may be performed concurrently as opposed to sequentially. In addition, some steps may be optional or may not be performed. The steps may be performed by the processing element 16 and/or one or more of the processing elements 26 via hardware, software, firmware, or combinations thereof. Furthermore, the steps may be implemented as instructions, code, code segments, code statements, a program, an application, an app, a process, a service, a daemon, or the like, and may be stored on a computer-readable storage medium, such as memory elements associated with the processing element 16 and/or the processing elements 26.

Referring to step 301, serial communication for each node controller 12 is disabled. Each node controller 12 may monitor and/or manage the operation of the components of the mobile tower 104 with which the node controller 12 is associated. Each node controller 12 may transmit and receive data to and from the main controller 14 and other node controllers 12. Each node controller 12 includes a first port 20, a second port 22, a processing port 24, and a processing element 26, as shown in FIG. 4. The first port 20, the second port 22, and the processing port 24 may form or may embody a network switch 28 which has a network address, such as an internet protocol (IP) address or a media access control (MAC) address. The network switch 28 is configured to handle (i.e., transmit and receive) packet-based data, such as ethernet network data.

The first port 20 and the second port 22 each may have a component structure that is substantially similar to, or the same as, the structure of the first port 18 of the main controller 14 and may connect to an electrically conductive metal or metal alloy cable or to an optical fiber cable.

The processing port 24 generally receives and transmits data to and from the first port 20 and the second port 22 and provides communication with the processing element 26. Any data that is addressed to the current node controller 12 is received from the first port 20 or the second port 22, is communicated to the processing port 24, and is forwarded to the processing element 26. Any data intended for the main controller 14 is communicated from the processing element 26 to the processing port 24, transferred to the first port 20, and transmitted to the inbound node controller 12 or to the main controller 14. The processing port 24 includes electronic circuitry, such as filters, amplifiers, and the like, configured to transmit and receive an electronic signal that includes data. The processing port 24 may communicate through electrically conductive components, such as electrically conductive traces on a printed circuit board.

The processing element 26 may have a structure that is substantially similar to, or the same as, the structure of the processing element 16. The processing element 26 may be operable, configured, and/or programmed to perform the functions, processes, methods, or algorithms of the node controller 12, such as monitor and/or manage the operation of the components of the mobile tower 104 with which the node controller 12 is associated, by utilizing hardware, software, firmware, or combinations thereof.

The second port 22, and optionally the first port 20 and the processing port 24, are capable of selectively being enabled or disabled through software settings. For example, the second port 22 may be disabled so that it does not transmit or receive any signals or may be enabled so that it does transmit and receive signals. When all the ports 20, 22 are enabled, the network switch 28 performs a switching function. That is, data, or packets, are received on the first port 20 and the second port 22. Those packets that are intended for the associated node controller 12 are transferred to the processing port 24 to be communicated to the processing element 26. Those packets that are intended for other node controllers 12 or the main controller 14 are transferred from the first port 20 to the second port 22 or from the second port 22 to the first port 20, depending on the direction of data flow.

Referring to step 302, a node ID counter is initialized with a value of 1 by each node controller 12.

Referring to step 303, communication between each node controller 12 and the main controller 14 is established for each node controller 12 in order of a position of the associated mobile tower 104. Each node controller 12 (repeatedly) tries to contact, ping, or send an announcement message to, the main controller 14. Since the second port 22 of each node controller 12 is disabled, only the first node controller 12 can communicate with the main controller 14. The first node controller 12 transmits a message to the main controller 14. The remaining node controllers 12 transmit a message to the main controller 14 as the steps listed below are performed repeatedly in sequence.

Referring to step 304, communication between each node controller 12 and the other node controllers 12 is established along a first direction of the mobile towers 104. The first direction is in the direction of mobile towers 104 with decreasing positional numbers. Since many of the steps of the method 300 are performed repeatedly in sequence, serial communication is available for those node controllers 12 with a node ID number (which corresponds to the positional number of the associated mobile tower 104) already assigned and is not available for those node controllers 12 without a node ID number. Thus, those node controllers 12 with smaller node ID numbers can be contacted by those node controllers 12 with larger node ID numbers. For example, when performing the current step for the third node controller 12, it can contact the first node controller 12 and the second node controller 12 since their node ID numbers have been assigned and serial communications have been enabled. But, the third node controller 12 cannot contact the fourth node controller 12 and higher because serial communication for the third node controller 12 (and higher) have not been enabled yet.

Referring to step 305, the node ID counter is incremented each time communication is established between the node controller 12 and each of the other node controllers 12 along the first direction of the mobile towers 104. Continuing the example from above, when performing the current step for the third node controller 12, the third node controller 12 will have incremented its node ID counter twice-once for the first node controller 12 and once for the second node controller 12. Since the node ID counter started with a value of 1, the value after incrementing will be 3. And as discussed above, the third node controller 12 cannot contact the fourth node controller 12 and higher so the node ID counter for the third node controller 12 cannot be incremented further.

Referring to step 306, a node ID number is assigned to each node controller 12 when the node controller 12 establishes communication with the other node controllers 12 along the first direction of the mobile towers 104. The node ID number is assigned according to a value of the node ID counter. Continuing the example from above, when performing the current step for the third node controller 12, the third node controller 12 has contacted the first node controller 12 and the second node controller 12. Thus, the third node controller 12 assigns itself the node ID number of 3, corresponding to the value of its node ID counter.

Referring to step 307, serial communication for each node controller 12 is enabled after its node identification number is assigned. Serial communication is enabled by the node controller 12 to enabling its second port 22, which allows node controllers 12 with higher node ID numbers to communicate through node controllers 12 with lower node ID numbers.

### ADDITIONAL CONSIDERATIONS

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112 (f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A control system for use with an irrigation system that includes a plurality of towers, the control system comprising:
a plurality of node controllers, each node controller associated with a successive one of the towers and configured to monitor operation of a plurality of components of the tower and to transmit data that includes a node identification number which corresponds to a positional number of the associated tower; and
a main controller configured to receive the data;
wherein the control system executes a configuration process in which each node controller is assigned the node identification number in a sequence.

2. The control system of claim 1, wherein the sequence of the node controllers follows the positional number of the tower associated with each node controller.

3. The control system of claim 1, wherein the main controller and the node controllers are connected to one another to form a serial communication network in which data flows through one or more node controllers to be received by the main controller or other node controllers.

4. The control system of claim 1, wherein each node controller includes a first port and a second port, each port configured to transmit and receive data, and data not intended for the associated node controller is transferred from the first port to the second port or from the second port to the first port.

5. The control system of claim 4, wherein the first port and the second port form at least a portion of a network switch.

6. The control system of claim 4, wherein each node controller includes
a processing element configured to monitor operation of the associated tower, and
a third port in communication with the first port and the second port and configured to communicate data intended for the node controller to the processing element.

7. The control system of claim 4, wherein during the configuration process, the second port of each node controller is initially disabled and is enabled when the node controller establishes communication with the main controller.

8. The control system of claim 7, wherein enabling the second port of each node controller allows at least one of the other node controllers associated with a tower that has a higher positional number to establish communication with the main controller.

9. A method for assigning a successive one of a plurality of node identification numbers to each of a plurality of node controllers connected in series with one another and a main controller to form a serial communication network, each node controller associated with a successive one of a plurality of towers of an irrigation system, the method comprising:
disabling serial communication for each node controller;
establishing communication between each node controller and the main controller for each node controller in order of a position of the associated tower;
assigning a node identification number to each node controller when the node controller establishes communication with the main controller; and
enabling serial communication for each node controller after its node identification number is assigned.

10. The method of claim 9, further comprising initializing a counter by the main controller;
incrementing the counter each time communication is established between the main controller and a successive one of the node controllers; and
assigning the node identification number to each node controller according to a value of the counter.

11. The method of claim 9, wherein each node controller includes a first port configured to establish communication along the first direction of the towers and a second port configured to establish communication along a second direction of the towers, and disabling serial communication for the node controller involves disabling the second port.

12. The method of claim 11, wherein enabling serial communication for the node controller involves enabling the second port.

13. The method of claim 11, wherein serial communication for each node controller involves transferring data from the first port to the second port or from the second port to the first port.

14. The method of claim 9, further comprising entering a mode of operation for each node controller after having been assigned the node identification number, the mode involving transmitting data to the main controller that includes the node identification number.

15. A method for assigning a successive one of a plurality of node identification numbers to each of a plurality of node controllers connected in series with one another and a main controller to form a serial communication network, each node controller associated with a successive one of a plurality of towers of an irrigation system, the method comprising:
disabling serial communication for each node controller;
establishing communication between each node controller and the main controller for each node controller in order of a position of the associated tower;
establishing communication between each node controller and the other node controllers along a first direction of the towers;
assigning a node identification number to each node controller after it establishes communication with the other node controllers along the first direction of the towers; and
enabling serial communication for each node controller after its node identification number is assigned.

16. The method of claim 15, further comprising initializing a counter by each node controller;
incrementing the counter each time communication is established between the node controller and each of the other node controllers along the first direction of the towers; and
assigning the node identification number to each node controller according to a value of the counter.

17. The method of claim 15, wherein each node controller includes a first port configured to establish communication along the first direction of the towers and a second port configured to establish communication along a second direction of the towers, and disabling serial communication for the node controller involves disabling the second port.

18. The method of claim 17, wherein enabling serial communication for the node controller involves enabling the second port.

19. The method of claim 17, wherein serial communication for each node controller involves transferring data from the first port to the second port or from the second port to the first port.

20. The method of claim 15, further comprising entering a mode of operation for each node controller after having been assigned the node identification number, the mode involving transmitting data to the main controller that includes the node identification number.
